(19) United States
(12) Patent Application Publication
(10) Pub. No.: US 2025/0388314 A1
(43) Pub. Date: Dec. 25, 2025

(54) SLIDE ON WINGS AND SERVO CONTROL

(71) Applicant: AeroVironment, Inc., Arlington, VA (US)

(72) Inventor: William John Nicoloff, Camarillo, CA (US)

(21) Appl. No.: 19/245,060

(22) Filed: Jun. 20, 2025

Related U.S. Application Data
(60) Provisional application No. 63/663,019, filed on Jun. 21, 2024.

(51) Int. Cl. B64C 3/48; B64C 1/26

(52) U.S. Cl. CPC B64C 3/48; B64C 1/26

(57) ABSTRACT

Systems, devices, and methods including: an assembly configured to maintain a wing on an aircraft, the assembly comprising: a connector configured to removably connect to a first portion of the wing; and an actuator having a mechanism configured to removably engage a second portion of the wing, the second portion of the wing is configured to be moveable; wherein the actuator is configured to control the second portion of the wing.

### CROSS-REFERENCE TO RELATED APPLICATION

This application claims the priority benefit of U.S. Provisional Patent Application Ser. No. 63/663,019 filed Jun. 21, 2024, which is incorporated herein by reference in its entirety.

### TECHNICAL FIELD

Embodiments relate generally to aircraft, and more particularly to control of control surfaces on aircraft.

### BACKGROUND

Aircraft may include wings having one or more control surfaces. These control surface may be used to control movement of the aircraft in flight. Control surfaces may be controlled by one or more motors or servos.

### SUMMARY

A system embodiment disclosed herein comprises: an assembly configured to maintain a wing on an aircraft, the assembly comprising: a connector configured to removably connect to a first portion of the wing; and an actuator having a mechanism configured to removably engage a second portion of the wing, the second portion of the wing is configured to be moveable; wherein the actuator is configured to control the second portion of the wing.

In another embodiment, the connector may include one or more first apertures; wherein the connector may be configured to removably connect to the first portion of the wing by receiving one or more spars of the first portion of a wing via the one or more first apertures.

In another embodiment, the system may further comprise at least one pin, wherein the at least one pin may be configured to be inserted through one or more second aperture of the connector into a notch of at least one spar of the one or more spars such that the wing may be prevented to be removed from the connector.

In another embodiment, while the one or more spars are configured to be slid into the connector via the one or more first apertures in a first direction, the at least one pin may be configured to slid into the connector via the one or more second aperture in a second direction perpendicular to the first direction, and wherein the at least one pin may be configured to be interlocked with the notch of at least one spar of the one or more spars.

In another embodiment, the actuator may comprise an arm configured to transfer motion from the actuator to the second portion of the wing, and wherein the arm may comprise a top portion and a bottom portion that are configured to receive at least a portion of the second portion of the wing when the first portion of the wing is received by the connector.

In another embodiment, when the first portion of the wing is received by the connector, the top portion of the arm may be configured to face a top surface of the second portion of the wing, and the bottom portion of the arm may be configured to face a bottom surface of the second portion of the wing.

In another embodiment, the top portion and the bottom portion of the arm may be configured to receive the second portion of the wing from a side edge of the second portion of the wing.

In another embodiment, the arm may comprise a mouth shape including the top portion and the bottom portion.

In another embodiment, the arm of the actuator may be configured to adjust a position of the second portion of the wing relative to the connector via movement of the arm by the actuator.

In another embodiment, the assembly may be configured to be connected to a spine of a fuselage of the aircraft.

A method embodiment disclosed herein comprises: pulling one or more pins of a connector; inserting one or more spars of a first portion of a wing into the connector; inserting a second portion of the wing into an actuator; releasing the one or more pins to secure the wing to the connector; and adjusting a position of the second portion of the wing via movement of the actuator.

In another embodiment, inserting the second portion of the wing into the actuator may include inserting the second portion of the wing between a top portion and a bottom portion of a mouth-shaped arm of the actuator, and wherein adjusting the position of the second portion of the wing may include adjusting the position of the second portion of the wing via movement of the mouth-shaped arm of the actuator.

In another embodiment, inserting the one or more spars of the first portion of the wing into the connector may include inserting the one or more spars into one or more first apertures of the connector, and wherein pulling the one or more pins of the connector may include pulling the one or more pins from one or more second apertures of the connector.

In another embodiment, releasing the one or more pins to secure the wing to the connector may include releasing the one or more pins through the one or more second apertures of the connector such that an end of the one or more pins is snapped into a notch of the one or more spars that are inserted through the one or more first apertures of the connector.

In another embodiment, the system may further comprise: pulling the one or more pins that are snapped into the notch of the one or more spars until the one or more pins are released from the notch; removing the one or more spars of the first portion of the wing from the connector; and removing the second portion of the wing from the actuator.

A system embodiment disclosed herein comprises: an assembly configured to maintain a plurality of wings on an aircraft, the assembly comprising: a connector comprising a plurality of connecting portions, wherein each connecting portion of the connecting portions may be configured to removably connect to a first portion of each wing of the plurality of wings, respectively; and a plurality of actuators, wherein each actuator of the actuators may be configured to have a mechanism configured to removably engage a second portion of each wing of the plurality of wings, respectively, wherein the second portion of each wing may be configured to be moveable; wherein each actuator of the actuators may be configured to control the movable portion of the wing of the plurality of wings.

In another embodiment, each actuator of the actuators may be configured to control the second portion of the wing of the plurality of wings, independently.

In another embodiment, the assembly may be configured to connected to a spine of a fuselage of the aircraft.

In another embodiment, the assembly may be configured to maintain at least two of the plurality of wings in different directions.

In another embodiment, each connecting portion of the connecting portions may include one or more first apertures and one or more second apertures, wherein one or more spars of the first portion of the wing may be inserted via the one or more first apertures, wherein the at least one pin may be configured to be inserted via the one or more second apertures, and wherein the at least one pin inserted into the one or more second apertures may be configured to be snapped into a notch of the one or more spars inserted into the one or more first apertures.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a front top perspective view of a system for an assembly configured to maintain a wing on an aircraft, including a partially transparent view of a connector, according to one embodiment;

FIG. 2A depicts a front top perspective view of the system of FIG. 1, including an opaque view of a connector, according to one embodiment;

FIG. 2B depicts a front top perspective view of the system of FIG. 2A, showing a state in which a wing is removed from a connector, according to one embodiment;

FIG. 3 depicts a front top perspective view of the system of FIG. 1, showing a notched spar configured to secure a wing to a connector, according to one embodiment;

FIG. 4 depicts a close-up top perspective view of the system of FIG. 1, showing a notched spar configured to secure a wing to a connector, according to one embodiment;

FIG. 5 depicts a rear top perspective view of the system of FIG. 1, including a partially transparent view of a wing and a connector to show an arm of an actuator for controlling a moveable portion of a wing, according to one embodiment;

FIG. 6 shows a front top perspective view of FIG. 6, according to one embodiment;

FIG. 7 depicts a high-level flowchart of a method for securing a wing to a connector and controlling a moveable portion of a wing with an actuator, according to one embodiment;

FIG. 8 depicts an exemplified aircraft on which a system for an assembly configured to maintain a wing is applied, according to one embodiment;

FIG. 9 illustrates an example top-level functional block diagram of a computing device embodiment;

FIG. 10 shows a high-level block diagram and process of a computing system for implementing an embodiment of the system and process;

FIG. 11 shows a block diagram and process of an exemplary system in which an embodiment may be implemented; and

FIG. 12 depicts a cloud computing environment for implementing an embodiment of the system and process disclosed herein.

### DETAILED DESCRIPTION

The disclosed system and method allow for securing a wing or stabilizer to an aircraft without the need for one or more servos on the wing or stabilizer to control movement of a flight control surface, such as an elevator and a rudder. In the disclosed system and method, the actuator required for control of the flight control surface are disposed in a connector, which reduces the weight of the wing and allows for easier swapping of the wings of an aircraft.

The disclosed system and method may also provide one or more spring-loaded pins that may be used to hold one or more spars of the wing in place such that the wing does not detach from the connector once secured.

Using slide on wings, the servo control may be accomplished with a mouth-style control horn grabbing the control surface of the wing. In some aircraft with removable wings, the removable wings may have actuators (e.g., servos) located in the wing. The wing may key on to a spine of the aircraft. When the tailfin is slid on, there may be a receptacle mouth-style control horn on the servo that the center of rotation of that servo is in line with the hinge point of the wing.

The entire wing structure, including the wing and control surface, may slide in with three pins slide into a central structure, such as a connector that is configured to be disposed on a spine of the aircraft. The mouth-style control horn of the servo may allow the wing to slide into the servo.

By pulling the pin forward, it may disengage on one of the spars. There may be a notch in that spar, so a user may pull this pin out from the notch, and it may release to slide straight out. In some embodiments, this pin may be a spring loaded pin. This may have a ramp on it, so when the spar is slid in, it just pushes the spring-loaded pin out of the way, and once the spar is fully inserted and the notch is aligned with the spring-loaded pin, the spring pushes, or snaps, the pin, into the notch, locking it in place.

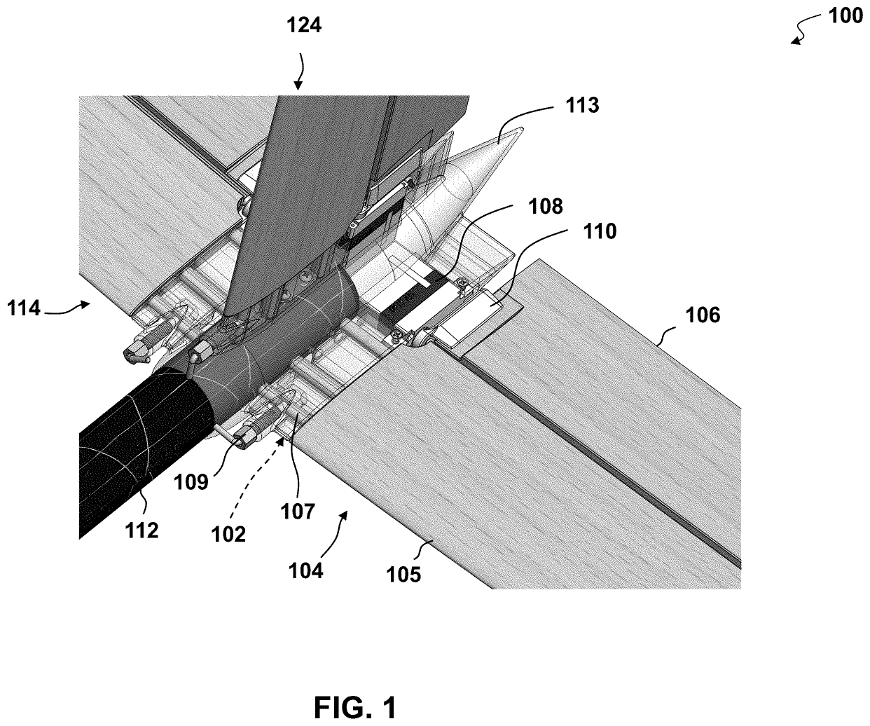

FIG. 1 depicts a front top perspective view of a system for an assembly configured to maintain a wing on an aircraft, including a partially transparent view of a connector. In FIG. 1, the top portion of the connector 102 is illustrated as transparent to reveal components disposed inside the connector 102, such as a spar 107 of the wing 104 and a pin 109. With reference to FIG. 1, the system 100 may comprise an assembly configured to maintain at least one wing 104 on a vehicle (e.g., aircraft). The assembly may comprise: a connector 102 configured to removably connect to a first portion 105 of the wing 104; and an actuator 108 having a mechanism configured to removably engage a second portion 106 of the wing 104, wherein the second portion 106 of the wing 104 is configured to be moveable. Accordingly, the actuator 108 may be configured to control the second portion 106 of the wing 104 to adjust the aircraft's attitude or direction during flight, while the wing 104 is stably connected to the aircraft through the connection between the first portion 105 of the wing 104 and the connector 102.

The connector 102 may be connected to a main body of an aircraft. In some embodiments, the connector 102 may be connected to a portion of a fuselage 112 of the aircraft. In some embodiments, the fuselage of an aircraft may include a spine 112 configured to serve as a central load-bearing axis. The connector 102 may be detachably or releasably attached, connected, coupled, mounted, engaged, fastened, secured, or bonded to the spine 112, but the present disclosure is not limited thereto. The connector 102 may be directly or indirectly connected to the spine 112 in any suitable manner. In some embodiments, the connector 102 may have a tubular shape, or cylindrical shape, which includes an internal passage through which the spine 112 is inserted. In some embodiments, the fuselage 112 may be shown as being tubular. Other fuselage 112 dimensions are possible and contemplated.

In some embodiments, the connector 102 attached to the main body portion (e.g., spine 112) may be removably connected to the first portion 105 of the wing 104 via a connecting portion including interlocking engagement between the pin 109 and a notch of the spar 107 connected to one end of the first portion 105 of the wing 104. While the spar 107 connected to the first portion 105 may be slid into the connector 102 in a first direction, the pin 109 may be slide into the connector 102 in a second direction perpendicular to the first direction and may be interlocked with a notch of the spar 107. Using this interlocking engagement between the pin 109 and a notch of the spar 107, the first portion 105 of the wing 104 may be removably connected to the connector 102.

The actuator 108 may be located proximate the connector 102 or included in the connector 102 as a part. In some embodiments, the connector 102 may include a receiving slot proximate a portion where the first portion 105 of the wing 104 is connected, and the actuator 108 may be inserted into the receiving slot and detachably attached to the connector 102 inside the slot. In some embodiments, the connector 102 may extended along the spine 112 to include a rear portion in the back of the portion where the first portion 105 of the wing 104 is connected, and the receiving slot may be formed in the rear portion. In some embodiment, the connector 102 may be located near a tail of the aircraft, and the connector 102 may be extended to include the tail portion 113 which may cover the tail of the aircraft. In this case, in some embodiment, the receiving slot for the actuator 108 may be located between the portion where the first portion 105 of the wing 104 is connected and the tail portion 113.

While the connector 102 is configured to be connected to the first portion 105 of the wing 104, the actuator 108 may be engaged with the second portion 106 of the wing 104. Specifically, an arm 110 of the actuator 108 may be engaged with the second portion 106 of the wing 104 and transfer motion from the actuator 108 to the second portion 106. The arm 110 may have a mouth shape comprising a top portion and a bottom portion such that at least a portion of the second portion 106 of the wing 104 may be received between the top and bottom portion of the mouth-shaped arm 110 while the first portion 105 of the wing 104 is connected to the connector 102. As the second portion 106 of the wing 104 may a movable portion of the wing 104, the mouth-shaped arm 110 of the actuator 108 may adjust a position of the second portion 106 of the wing 104 relative to the connector 102 via movement of the arm 110 by the actuator 108. Accordingly, the mouth-shaped arm 110 of the actuator 108 may control the aircraft's attitude or direction during flight by redirecting airflow and changing the aircraft's motion, while the wing 104 is stably connected to the aircraft through the connection between the first portion 105 of the wing 104 and the connector 102. In addition, the mouth-shaped arm 110 eliminates the need for an actuator to be placed on the wing 104 and/or a movable portion of the wing 104. Accordingly, the wing 104 may be easily replaced if damaged, if another wing having other dimensions is desired, or the like.

In some embodiments, the second portion 106 of the wing 104 may include a flight control surface. As mentioned above, in one embodiment, the wing 104 may be a stabilizer, but the present system 100 is not limited thereto. Other wing types are possible and contemplated.

The actuator that is configured to control the movement of the second portion may be connected to a processor or flight control computer of the aircraft. The processor may send electrical signals to the actuator indicating how much to move based on inputs from an operator or autonomous flight software. In some embodiments, the actuator 108 may include a servo, and the arm 110 may include a mouth-style control horn. In these embodiments, A servo and mouth-style control horn may be disposed proximate the connector 102. In some embodiments, the servo may be a part of the connector. In other embodiment, the connector 102 may have a cut-out to allow for easy access to the servo such as for maintenance and/or replacement.

In the above embodiments, the second portion 106 of the wing 104 (e.g., flight control surface) may be slid into at least a portion of the mouth-style control horn such that the mouth-style control horn surrounds at least a portion of the second portion 106 of the wing 104. The servo may control movement of the mouth-style control horn such that the second portion 106 of the wing 104 may be moved relative to the connector 102 and/or the wing 104. The use of the mouth-style control horn and servo eliminates the need for a servo to be placed on the wing 104 and/or the movable portion of a wing, such as flight control surface. Accordingly, the wing 104 may be easily replaced if damaged, if another wing having other dimensions is desired, or the like.

While the connections are shown for a stabilizer and/or rear wing of an aircraft, the system and method disclosed herein may be used on any wing of an aircraft. That is, the present system 100 may be applied to any vehicle comprising a body portion to which the connector 102 is fixed and at least one wing 104 configured to connect to the body portion. In some embodiments, as shown in FIG. 1, the present system 100 may be configured to maintain at least one wing 104 on a tail portion 113 of an aircraft. That is, the at least one wing 104 on the tail portion 113 may be a stabilizer, including at least one of a horizontal stabilizer and a vertical stabilizer. In this case, the second portion 106 of the wing 104, which is configured to be movable, may be a control surface, such as an elevator and a rudder. In other embodiments, the present system 100 may be configured to maintain at least one wing on a front portion of an aircraft. In this case, the second portion 106 of the wing 104, which is configured to be movable, may be a control surface, such as a spoiler, an aileron, and a flap, and/or a lift device, such as a slat. The aircraft shown herein may be an unmanned aerial vehicle (UAV) in some embodiments.

In some embodiments, the connector 102 may be configured to removably connect to multiple wings 104, 114, 124, and each wing of the multiple wings 104, 114, 124 may include a portion configured to removably connect the connector 102 and a movable portion configured to removably engage an actuator via a mouth-shaped arm. Accordingly, the movable portions of the multiple wings 104, 114, 124 may be independently movable while the multiple wings 104, 114, 124 are stably connected to the aircraft via the single connector 102. In addition, as mentioned above, the mouth-shaped arms of the multiple wings 104, 114, 124 eliminate the need for actuators to be placed on the multiple wings 104, 114, 124 and/or movable portions of the multiple wings 104, 114, 124, respectively. Accordingly, each wing of the multiple wings 104, 114, 124 may be easily replaced if damaged, if another wing having other dimensions is desired, or the like. In some embodiments, the assembly configured to maintain the multiple wings 104, 114, 124 may be connected to the spine (112) of a fuselage of the aircraft. In this case, the assembly may maintain at least two of the plurality of wings (204, 214, 224) in different directions.

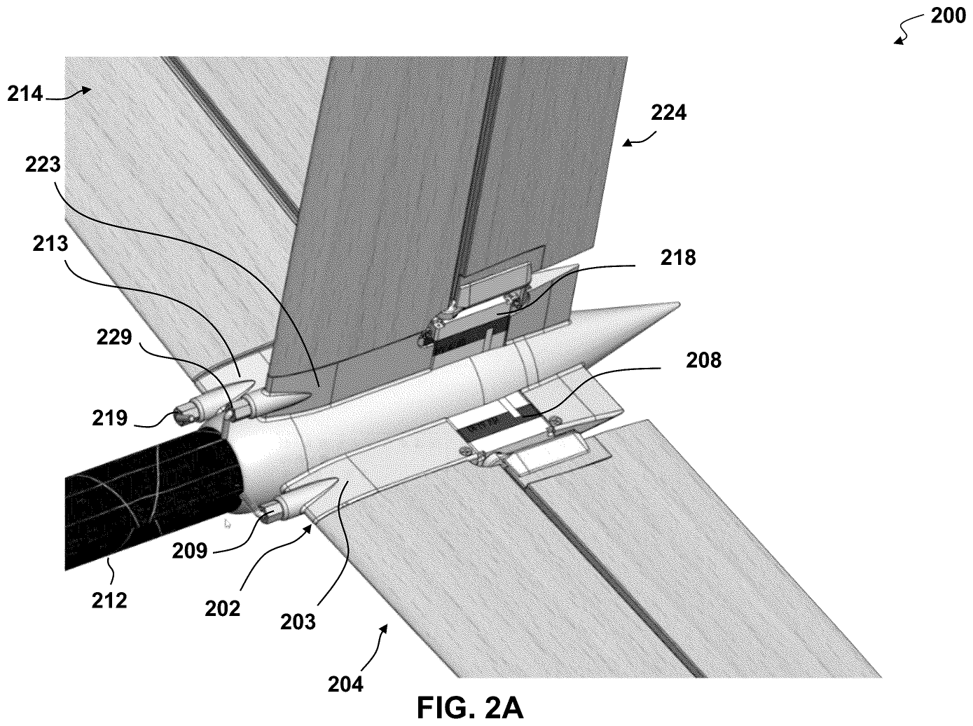

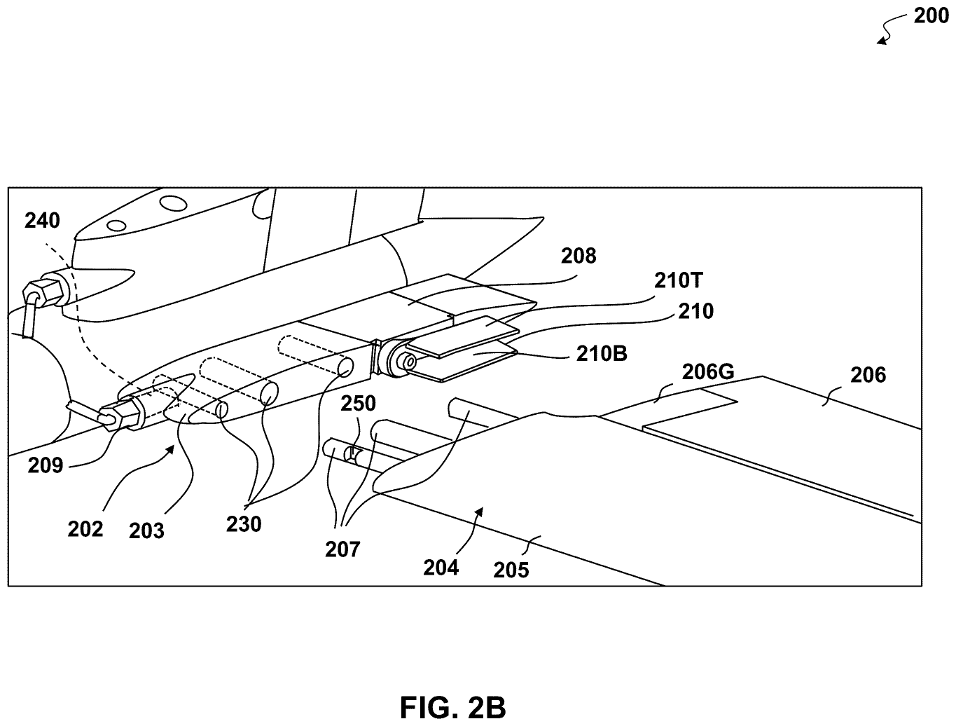

FIG. 2A depicts a front top perspective view of the system of FIG. 1, showing the one or more pins of the connector, including an opaque view of a connector. Unlike FIG. 1, which illustrates a top portion of the connector 102 as transparent,

FIG. 2A depicts the top portion of the connector 202 as viewed from the outside. Accordingly, internal components, such as the spar (107, FIG. 1) of the wing (104, FIG. 1) and a portion of the pin (109, FIG. 1) are not shown in FIG. 2A. With reference to FIG. 2A, the connector 202 may be connected to a portion of a fuselage of the aircraft. In some embodiments, the fuselage of an aircraft may include a spine 212, and the connector 202 may be coupled to or mounted on the spine 212. In this case, the connector 202 may have a tubular shape, or cylindrical shape, which includes an internal passage through which the spine 212 is inserted.

The connector 202 may include multiple connecting portions 203, 213, 223 where each connecting portion may be connected to each wing of multiple wings 204, 214, 224. In some embodiments, each connecting portion of the multiple connecting portions 203, 213, 223 of the connector 202 may include a structure protruded from the outer surface of the tubular shape of the connector 202. Inside the protruding structure of each of the connecting portions 203, 213, 223, the pin 209 (or 219, 229) and a notch of the spar (107, FIG. 1) connected to one end of a portion of the wing 204 may be interlocked. At least a portion of each pin of the one or more pins 209, 219, 229 may be disposed in the connector 202. In some embodiments, the one or more pins 209, 219, 229 may be spring-loaded. While the one or more pins 209, 219, 229 are shown as being front-facing, other arrangements are possible and contemplated.

Each actuator of multiple actuators 208, 218 may be located proximate or included in each connecting portion of the multiple connecting portions 203, 213, 223. When each connecting portion of the multiple connecting portions 203, 213, 223 of the connector 202 receives and connect a first portion of each wing of multiple wings 204, 214, 224. Each actuator of the multiple actuators 208, 218 may engage a second portion of each wing of multiple wings 204, 214, 224 and be configured to control a second portion of each wing of multiple wings 204, 214, 224, independently.

FIG. 2B depicts a front top perspective view of the system of FIG. 2A, showing a state in which a wing is removed or separated from a connector. With reference to FIG. 2B, the connector 202 may include one or more first apertures 230 configured to receive one or more spars 207 of the first portion 205 of the wing 204 and one or more second apertures 240 configured to receive one or more pins 209. Using the interlocking engagement between the pin 209 and the notch 250 of at least one spar 207, the first portion 205 of the wing 204 may removably connect to the connector 202.

The actuator 208 may be located proximate the connector 202 or included in the connector 202 as part of the connector 202 and may include a mouth-shaped arm 210 configured to transfer motion from the actuator 208 to the second portion 206 of the wing 204. The mouth-shaped arm 210 may comprise a top portion 210T and a bottom portion 210B that are configured to receive at least a portion of the second portion 206 of the wing 204, while the first portion 205 of the wing 204 is received by the connector 202. When the first portion 205 of the wing 204 is received by the connector 202, the top portion 210T of the arm 210 may face a top surface of the second portion 206 of the wing 204, and the bottom portion 210B of the arm 210 may face a bottom surface of the second portion 206 of the wing 204. In this case, the top portion 210T and the bottom portion 210B of the arm 210 may receive the second portion 206 of the wing 204 from a side edge of the second portion 206 of the wing 204.

In some embodiments, the second portion 206 of the wing 204 may include a groove at a top side portion 206G and/or a bottom side portion (not shown) in which the top portion and the bottom portion of the mouth-shaped arm 210 are configured to face.

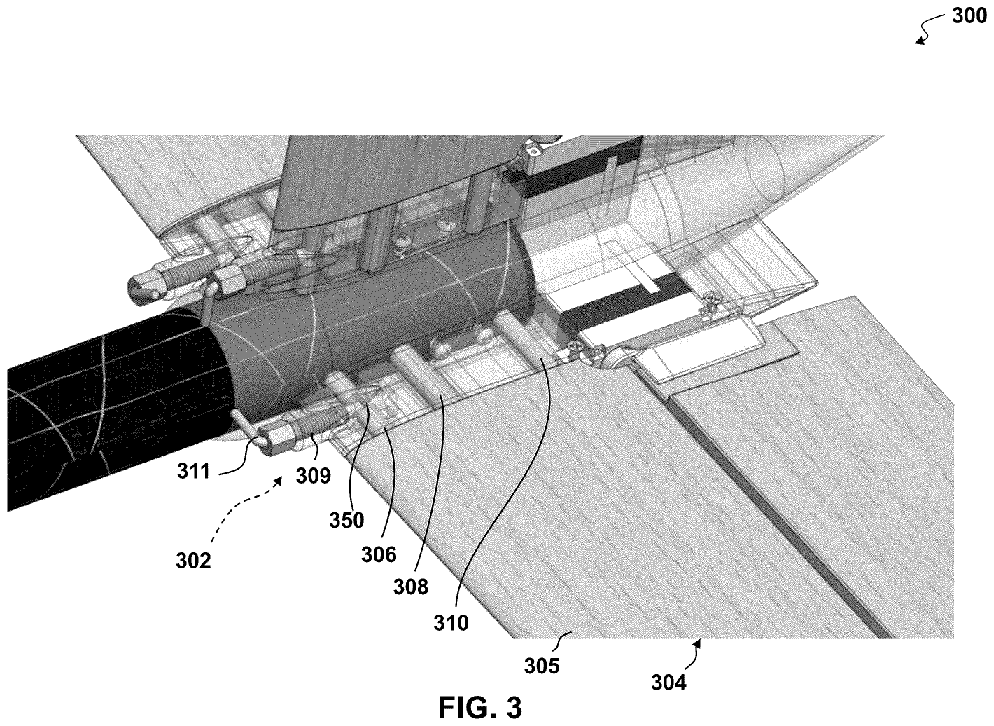

FIG. 3 depicts a front top perspective view of the system of FIG. 1, showing a notched spar configured to secure the wing to the connector. With reference to FIG. 3, the wing 304 may include one or more spars, or pins, 306, 308, 310. Specifically, the spars 306, 308, 310 may be connected to one end of the first portion 305 of the wing 304. These spars 306, 308, 310 may be received by one or more first apertures (230, FIG. 2B) in the connector 302 to allow the wing 304 to slide in and out relative to the connector 302. The pin 309 may include a spring 311 that is configured to maintain the pin 309 in a closed position. One of the spars 306, 308, 310 may include a notch 350 configured to receive and be interlocked with the pin 309. When the pin 09 is inserted into the notch 350, it is held in place by the spring 311 and the wing 304 cannot be removed from the connector 302. While a notch 350, spring 311, and pin 309 are shown, other methods for securing the wing 304 to the connector 302, such as via a screw, magnets, adhesives, or the like, are possible and contemplated.

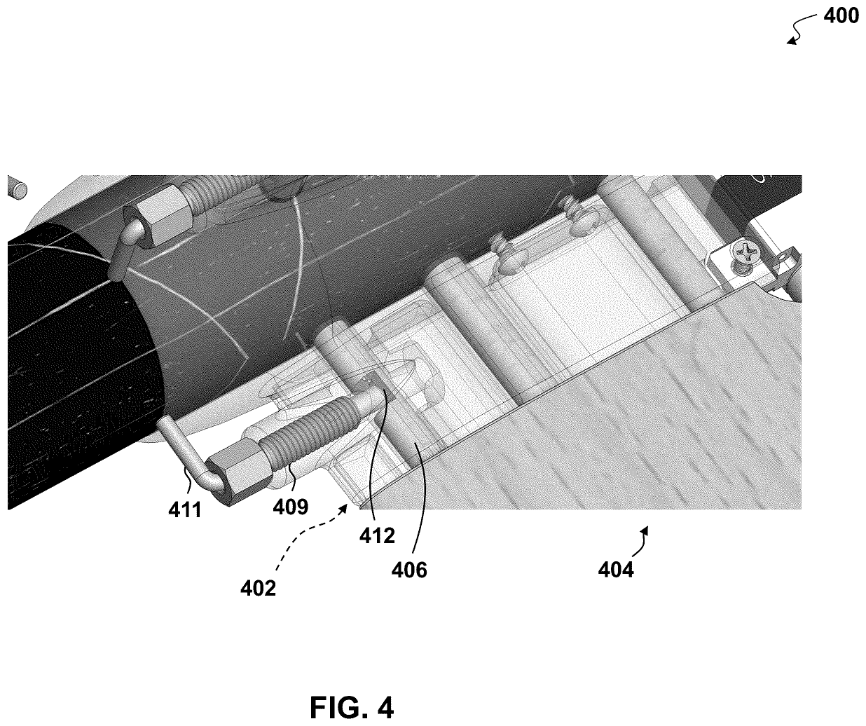

FIG. 4 depicts a close-up top perspective view of the system of FIG. 1, showing the notched pin configured to secure a wing to a connector. With reference to FIG. 4, the connector 402 and the wing 404 of the present system 400 may be connected using interlocking engagement between the pin 409 and a notch 412 of the spar 406. While the spar 406 connected to the first portion of the wing 404 may be slid into the connector 402 via an aperture (230, FIG. 2B) in a first direction, the pin 409 may be slid into the connector 402 via an aperture in a second direction perpendicular to the first direction and may be interlocked with a notch 412 of the spar 406.

In some embodiments, the pin 409 may include a spring 411 that is configured to maintain the pin 409 in a closed position where the pin 409 is pressed against the notch 412 of the spar 406 such that the wing 404 cannot be pulled out from the connector 402. By pulling the pin 409 out, the pin 409 is cleared of the notch 412 and the wing 404 may be removed from the connector 402. While this arrangement is shown for one wing, it may be applied to any number of wings, such as the two horizontal and one vertical stabilizer shown in FIG. 1.

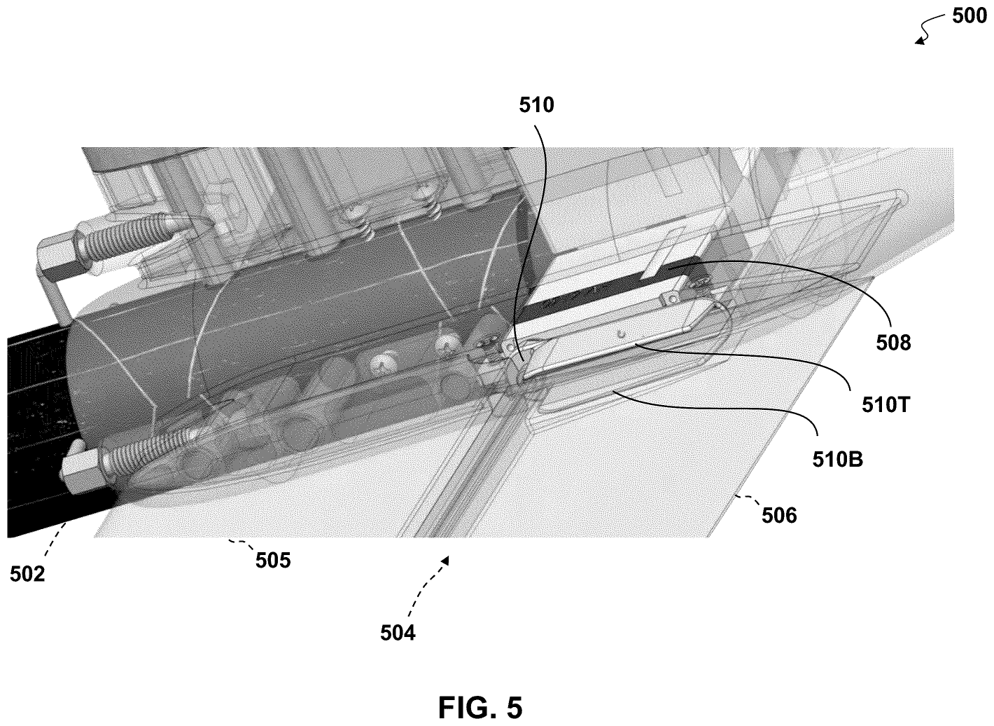

FIG. 5 depicts a rear top perspective view of the system of FIG. 1, including a partially transparent view of a wing and connector to show an arm of an actuator for controlling a movable portion of a wing. With reference to FIG. 5, the actuator 508 of the system 500 may include a mouth-shaped arm 510 (e.g., mouth-style control horn). The mouth-shaped arm 510 may include a top portion 510T and a bottom portion 510B configured to receive at least a portion of a movable portion 506 (e.g., flight control surface) of the wing 504 when the first portion 505 of the wing 504 is received by the connector 502. In some embodiments, the mouth-shaped arm 510 of the actuator 508 may be a mouth-style control horn of a servo. The mouth-style control horn 110 of the servo 108 is configured to adjust a position of the movable portion 506 of the wing 504 (e.g., flight control surface) relative to the connector 502 via movement of the mouth-style control horn by the servo.

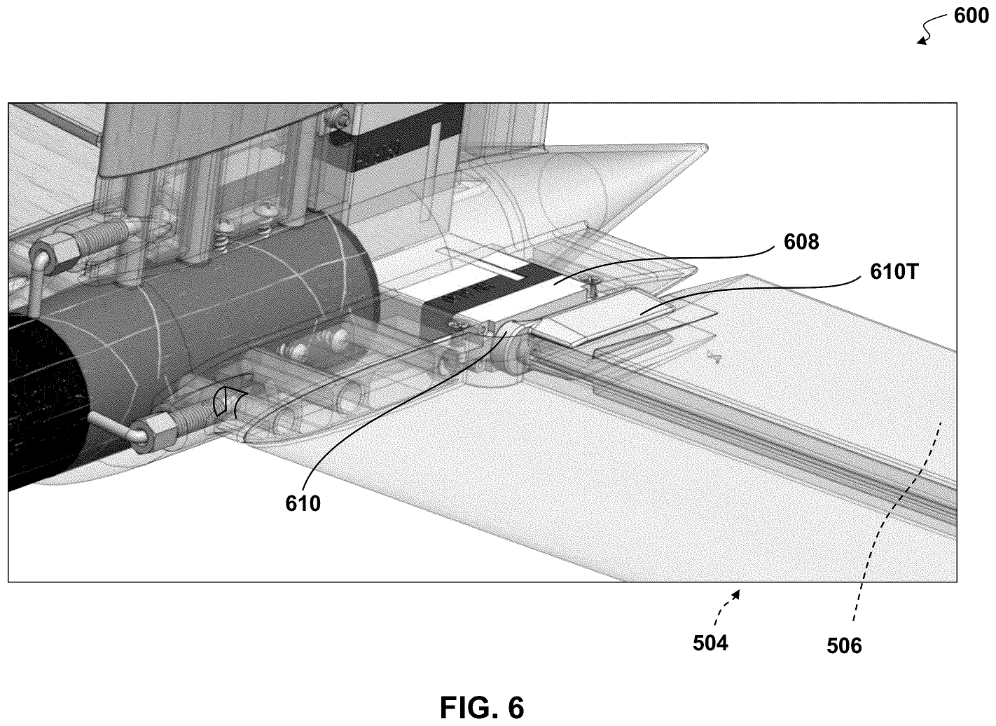

FIG. 6 depicts a front top perspective view of FIG. 5. In some embodiments, a mouth-shaped arm 610 of an actuator 608 of a system 600 may include a top portion 610T and a bottom portion 610B. In some embodiments, the top portion 610T of the mouth-shaped arm 610 (e.g., mouth-style control horn) and the bottom portion 610B of the mouth-shaped arm 610 may follow a curvature of the movable portion 506 (e.g., flight control surface). A portion of the flight control surface may fit between the top portion 610T of the mouth-shaped arm 610 and the bottom portion 610B of the mouth-shaped arm 610.

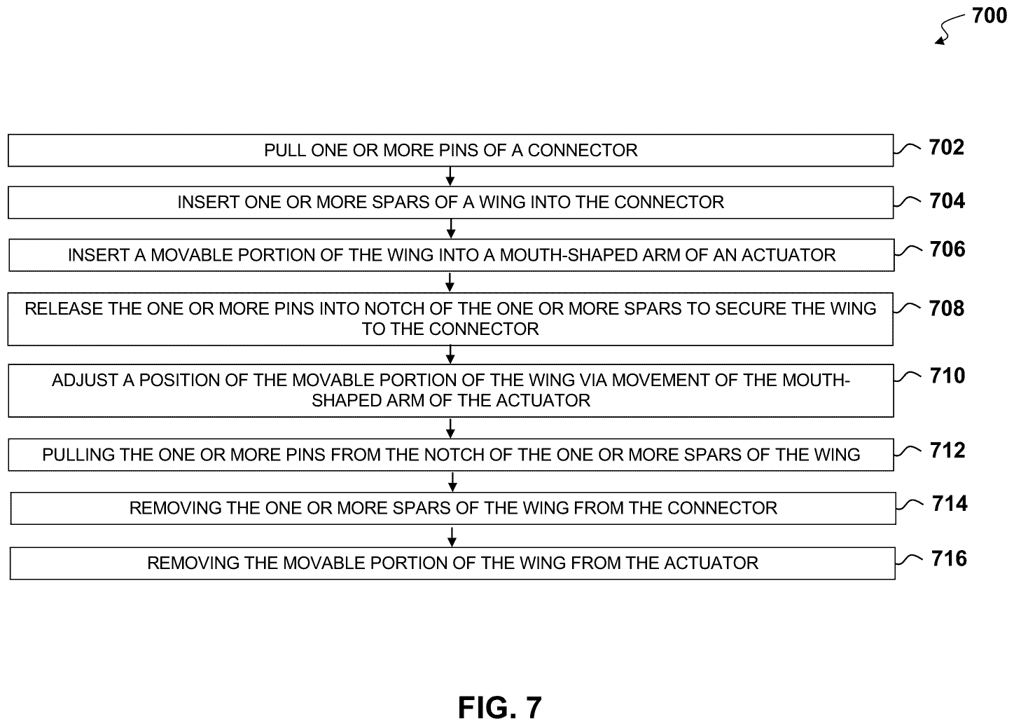

FIG. 7 depicts a high-level flowchart of a method 700 for re movably securing a wing to a connector and controlling a moveable portion of a wing (e.g., flight control surface) with an actuator (e.g., servo). With reference to FIG. 7, the method 700 may include: pulling one or more pins of a connector (step 702). The method 700 may then include inserting one or more spars of a wing into the connector (step 704). The method 700 may then include inserting a movable portion (e.g., flight control surface) of the wing into a mouth-shaped arm (e.g., mouth-style control horn) of an actuator (e.g., servo) (step 706). The method 700 may then include releasing the one or more pins to secure the wing to the connector (step 708). The method 700 may then include adjusting a position of the movable portion of the wing via movement of the mouth-shaped arm of the actuator (step 710).

In some embodiments, the step for inserting the second portion of the wing into the actuator (step 706) may include inserting the second portion of the wing between a top portion and a bottom portion of a mouth-shaped arm of the actuator, and the step for adjusting the position of the second portion of the wing (step 710) may include adjusting the position of the second portion of the wing via movement of the mouth-shaped arm of the actuator.

In some embodiments, the step for inserting the one or more spars of the first portion of the wing into the connector (step 704) may include inserting the one or more spars into one or more first apertures of the connector, and the step for pulling the one or more pins of the connector (step 702) may include pulling the one or more pins from one or more second apertures of the connector, and

In some embodiments, the step for releasing the one or more pins to secure the wing to the connector (step 708) may include releasing the one or more pins through the one or more second apertures of the connector such that an end of the one or more pins is snapped into a notch of the one or more spars that are inserted through the one or more first apertures of the connector.

The method 700 may also include the step for removing the wing from the connector. The method 700 may include: pulling the one or more pins that are snapped into the notch of the one or more spars until the one or more pins are released from the notch (step 712); removing the one or more spars of the first portion of the wing from the connector (step 714); and removing the second portion of the wing from the actuator (step 716).

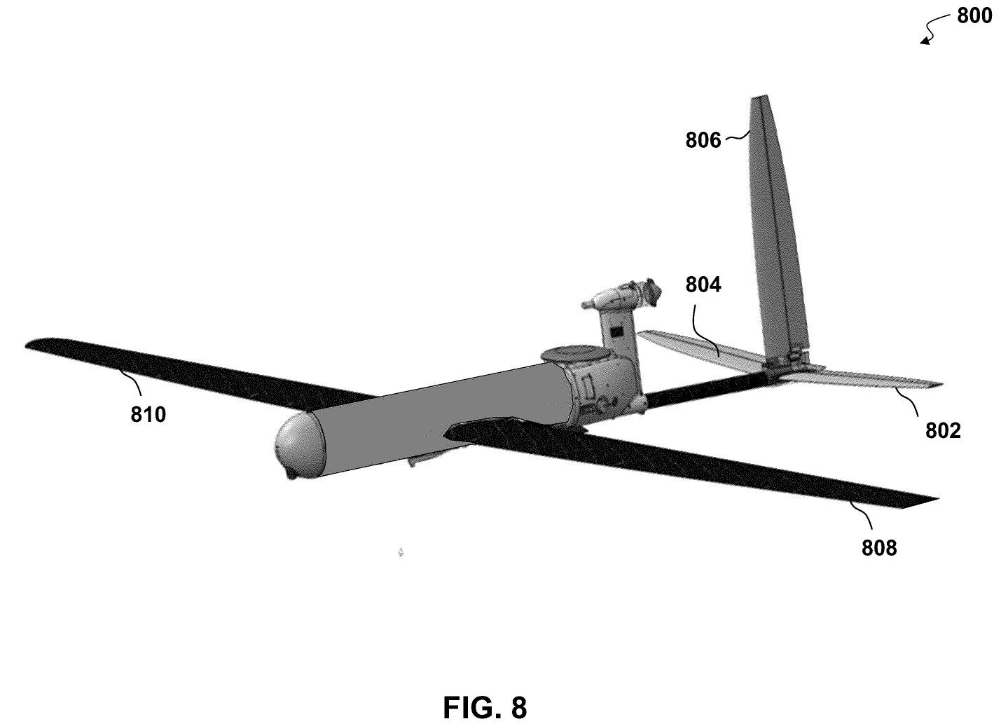

FIG. 8 depicts an exemplified aircraft on which a system for an assembly configured to maintain a wing is applied. With reference to FIG. 8, the present system 800 shown in FIGS. 1 to 6 may be configured to maintain at least one wing 802, 804, 806 on a tail portion of an aircraft, such as a stabilizer, including at least one of a horizontal stabilizer and a vertical stabilizer. In this case, the movable portion of each of the wings 802, 804, 806 may be a control surface, such as an elevator and a rudder. While FIGS. 1 to 6 illustrate the connections for a stabilizer and/or rear wing of an aircraft, the system and method disclosed herein may be used on any wing of an aircraft. In some embodiments, the present system 800 may be configured to maintain at least one wing 808, 810 on a front portion of an aircraft. In this case, the movable portion of each of the wings 808, 810 may be a control surface, such as a spoiler, an aileron, and a flap, and/or a lift device, such as a slat.

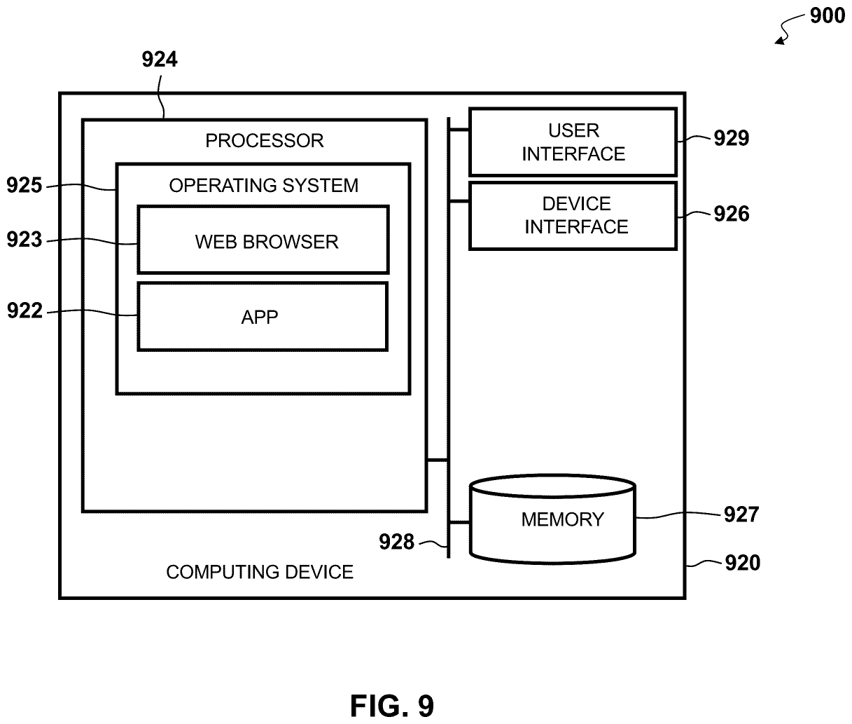

FIG. 9 illustrates an example of a top-level functional block diagram of a computing device embodiment 900. The example operating environment is shown as a computing device 920 comprising a processor 924, such as a central processing unit (CPU), addressable memory 927, an external device interface 926, e.g., an optional universal serial bus port and related processing, and/or an Ethernet port and related processing, and an optional user interface 929, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 928. In some embodiments, via an operating system 925 such as one supporting a web browser 923 and applications 922, the processor 924 may be configured to execute steps of a process establishing a communication channel and processing according to the embodiments described above.

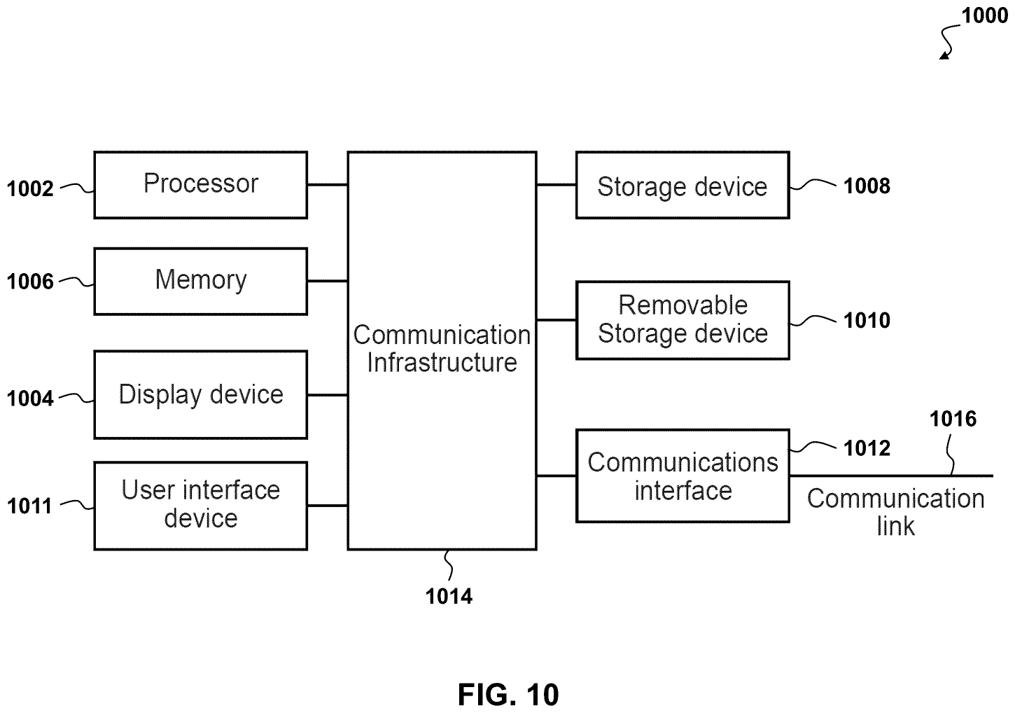

FIG. 10 is a high-level block diagram 1000 showing a computing system comprising a computer system useful for implementing an embodiment of the system and process, disclosed herein. Embodiments of the system may be implemented in different computing environments. The computer system includes one or more processors 1002, and can further include an electronic display device 1004 (e.g., for displaying graphics, text, and other data), a main memory 1006 (e.g., random access memory (RAM)), storage device 1008, a removable storage device 1010 (e.g., removable storage drive, a removable memory module, a magnetic tape drive, an optical disk drive, a computer readable medium having stored therein computer software and/or data), user interface device 1011 (e.g., keyboard, touch screen, keypad, pointing device), and a communication interface 1012 (e.g., modem, a network interface (such as an Ethernet card), a communications port, or a PCMCIA slot and card). The communication interface 1012 allows software and data to be transferred between the computer system and external devices. The system further includes a communications infrastructure 1014 (e.g., a communications bus, cross-over bar, or network) to which the aforementioned devices/modules are connected as shown.

Information transferred via communications interface 1014 may be in the form of signals such as electronic, electromagnetic, optical, or other signals capable of being received by communications interface 1014, via a communication link 1016 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1012. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

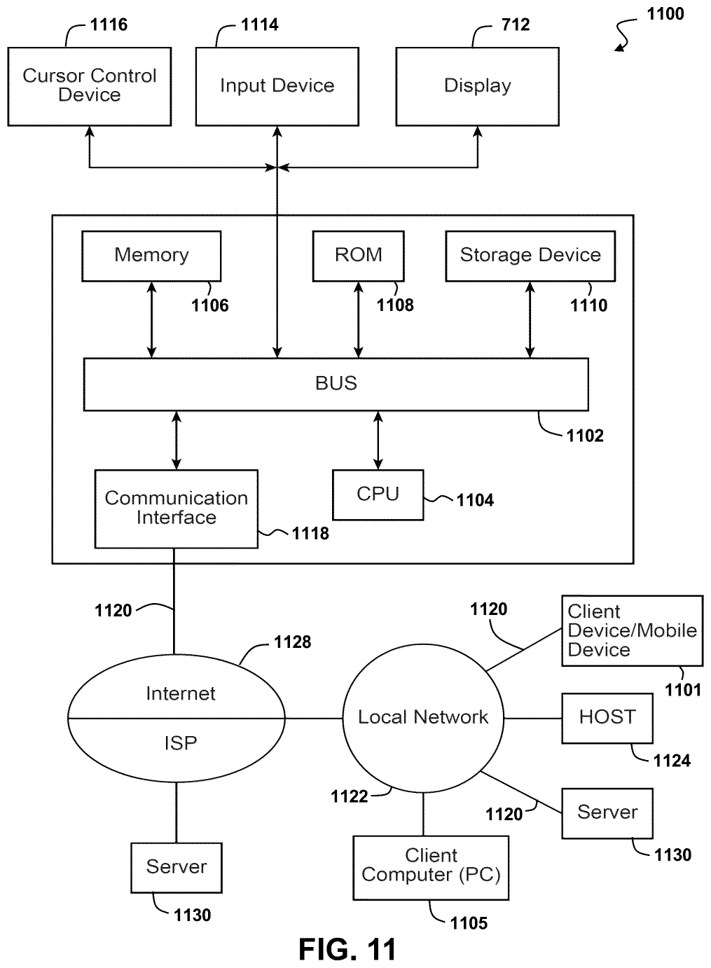

FIG. 11 shows a block diagram of an example system 1100 in which an embodiment may be implemented. The system 1100 includes one or more client devices 1101 such as consumer electronics devices, connected to one or more server computing systems 1130. A server 1130 includes a bus 1102 or other communication mechanism for communicating information, and a processor (CPU) 1104 coupled with the bus 1102 for processing information. The server 1130 also includes a main memory 1106, such as a random access memory (RAM) or other dynamic storage device, coupled to the bus 1102 for storing information and instructions to be executed by the processor 1104. The main memory 1106 also may be used for storing temporary variables or other intermediate information during execution or instructions to be executed by the processor 1104. The server computer system 1130 further includes a read only memory (ROM) 1108 or other static storage device coupled to the bus 1102 for storing static information and instructions for the processor 1104. A storage device 1110, such as a magnetic disk or optical disk, is provided and coupled to the bus 1102 for storing information and instructions. The bus 1102 may contain, for example, thirty-two address lines for addressing video memory or main memory 1106. The bus 1102 can also include, for example, a 32-bit data bus for transferring data between and among the components, such as the CPU 1104, the main memory 1106, video memory and the storage 1110. Alternatively, multiplex data/address lines may be used instead of separate data and address lines.

The server 1130 may be coupled via the bus 1102 to a display 1112 for displaying information to a computer user. An input device 1114, including alphanumeric and other keys, is coupled to the bus 1102 for communicating information and command selections to the processor 1104. Another type or user input device comprises cursor control 1116, such as a mouse, a trackball, or cursor direction keys for communicating direction information and command selections to the processor 1104 and for controlling cursor movement on the display 1112.

According to one embodiment, the functions are performed by the processor 1104 executing one or more sequences of one or more instructions contained in the main memory 1106. Such instructions may be read into the main memory 1106 from another computer-readable medium, such as the storage device 1110. Execution of the sequences of instructions contained in the main memory 1106 causes the processor 1104 to perform the process steps described herein. One or more processors in a multi-processing arrangement may also be employed to execute the sequences of instructions contained in the main memory 1106. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1104 for execution. Such a medium may take many forms, including but not limited to, non-volatile media, volatile media, and transmission media. Non-volatile media includes, for example, optical or magnetic disks, such as the storage device 1110. Volatile media includes dynamic memory, such as the main memory 1106. Transmission media includes coaxial cables, copper wire and fiber optics, including the wires that comprise the bus 1102. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1104 for execution. For example, the instructions may initially be carried on a magnetic disk of a remote computer. The remote computer can load the instructions into its dynamic memory and send the instructions over a telephone line using a modem. A modem local to the server 1130 can receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1106, from which the processor 1104 retrieves and executes the instructions. The instructions received from the main memory 1106 may optionally be stored on the storage device 1110 either before or after execution by the processor 1104.

The server 1130 also includes a communication interface 1118 coupled to the bus 1102. The communication interface 1118 provides a two-way data communication coupling to a network link 1120 that is connected to the world wide packet data communication network now commonly referred to as the Internet 1128. The Internet 1128 uses electrical, electromagnetic or optical signals that carry digital data streams. The signals through the various networks and the signals on the network link 1120 and through the communication interface 1118, which carry the digital data to and from the server 1130, are exemplary forms or carrier waves transporting the information.

In another embodiment of the server 1130, interface 1118 is connected to a network 1122 via a communication link 1120. For example, the communication interface 1118 may be an integrated services digital network (ISDN) card or a modem to provide a data communication connection to a corresponding type of telephone line, which can comprise part of the network link 1120. As another example, the communication interface 1118 may be a local area network (LAN) card to provide a data communication connection to a compatible LAN. Wireless links may also be implemented. In any such implementation, the communication interface 1118 sends and receives electrical electromagnetic or optical signals that carry digital data streams representing various types of information.

The network link 1120 typically provides data communication through one or more networks to other data devices. For example, the network link 1120 may provide a connection through the local network 1122 to a host computer 1124 or to data equipment operated by an Internet Service Provider (ISP). The ISP in turn provides data communication services through the Internet 1128. The local network 1122 and the Internet 1128 both use electrical, electromagnetic or optical signals that carry digital data streams. The signals through the various networks and the signals on the network link 1120 and through the communication interface 1118, which carry the digital data to and from the server 1130, are exemplary forms or carrier waves transporting the information.

The server 1130 can send/receive messages and data, including e-mail, program code, through the network, the network link 1120 and the communication interface 1118. Further, the communication interface 1118 can comprise a USB/Tuner and the network link 1120 may be an antenna or cable for connecting the server 1130 to a cable provider, satellite provider or other terrestrial transmission system for receiving messages, data and program code from another source.

The example versions of the embodiments described herein may be implemented as logical operations in a distributed processing system such as the system 1100 including the servers 1130. The logical operations of the embodiments may be implemented as a sequence of steps executing in the server 1130, and as interconnected machine modules within the system 1100. The implementation is a matter of choice and can depend on performance of the system 1100 implementing the embodiments. As such, the logical operations constituting said example versions of the embodiments are referred to for e.g., as operations, steps or modules.

Similar to a server 1130 described above, a client device 1101 can include a processor, memory, storage device, display, input device and communication interface (e.g., e-mail interface) for connecting the client device to the Internet 1128, the ISP, or LAN 1122, for communication with the servers 1130.

The system 1100 can further include computers (e.g., personal computers, computing nodes) 1105 operating in the same manner as client devices 1101, where a user can utilize one or more computers 1105 to manage data in the server 1130.

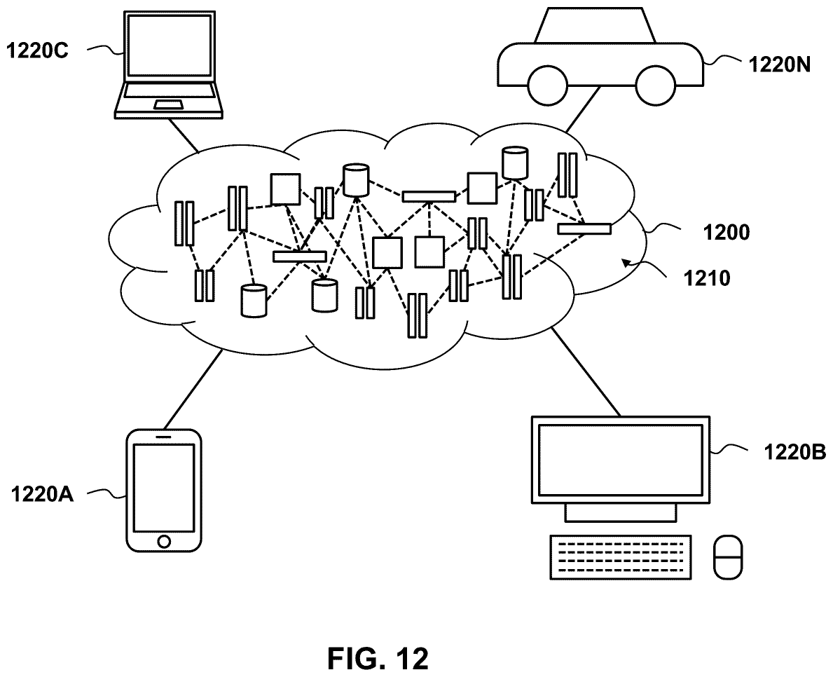

Referring now to FIG. 12, illustrative cloud computing environment 1200 is depicted. As shown, cloud computing environment 1200 comprises one or more cloud computing nodes 1210 with which local computing devices used by cloud consumers, such as, for example, personal digital assistant (PDA), smartphone, smart watch, set-top box, video game system, tablet, mobile computing device, or cellular telephone 1220A, desktop computer 1220B, laptop computer 1220C, and/or automobile computer system 1220N may communicate. Nodes 1210 may communicate with one another. They may be grouped (not shown) physically or virtually, in one or more networks, such as Private, Community, Public, or Hybrid clouds as described hereinabove, or a combination thereof. This allows cloud computing environment 1200 to offer infrastructure, platforms and/or software as services for which a cloud consumer does not need to maintain resources on a local computing device. It is understood that the types of computing devices 1220A-N shown in FIG. 10 are intended to be illustrative only and that computing nodes 1210 and cloud computing environment 1200 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
an assembly configured to maintain a wing on an aircraft, the assembly comprising:
a connector configured to removably connect to a first portion of the wing; and
an actuator having a mechanism configured to removably engage a second portion of the wing, wherein the second portion of the wing is configured to be moveable, and wherein the actuator is configured to control the second portion of the wing.

2. The system of claim 1, wherein the connector includes one or more first apertures;
wherein the connector is configured to removably connect to the first portion of the wing by receiving one or more spars of the first portion of a wing via the one or more first apertures.

3. The system of claim 2, further comprising at least one pin,
wherein the at least one pin is configured to be inserted through one or more second aperture of the connector into a notch of at least one spar of the one or more spars such that the wing is prevented to be removed from the connector.

4. The system of claim 3, wherein while the one or more spars are configured to be slid into the connector via the one or more first apertures in a first direction, the at least one pin is configured to slid into the connector via the one or more second aperture in a second direction perpendicular to the first direction, and
wherein the at least one pin is configured to be interlocked with the notch of at least one spar of the one or more spars.

5. The system of claim 1, wherein the actuator comprises an arm, the arm configured to transfer motion from the actuator to the second portion of the wing,
wherein the arm comprises a top portion and a bottom portion, and
wherein the arm is configured to receive at least a portion of the second portion of the wing when the first portion of the wing is received by the connector.

6. The system of claim 5, wherein when the first portion of the wing is received by the connector, the top portion of the arm is configured to face a top surface of the second portion of the wing, and the bottom portion of the arm is configured to face a bottom surface of the second portion of the wing.

7. The system of claim 6, wherein the top portion and the bottom portion of the arm are configured to receive the second portion of the wing from a side edge of the second portion of the wing.

8. The system of claim 5, wherein the arm comprises a mouth shape including the top portion and the bottom portion.

9. The system of claim 5, wherein the arm of the actuator is configured to adjust a position of the second portion of the wing relative to the connector via movement of the arm by the actuator.

10. The system of claim 1, wherein the assembly is configured to be connected to a spine of a fuselage of the aircraft.

11. A method comprising:
pulling one or more pins of a connector;
inserting one or more spars of a first portion of a wing into the connector;
inserting a second portion of the wing into an actuator;
releasing the one or more pins to secure the wing to the connector; and
adjusting a position of the second portion of the wing via movement of the actuator.

12. The method of claim 11, wherein inserting the second portion of the wing into the actuator includes inserting the second portion of the wing between a top portion and a bottom portion of a mouth-shaped arm of the actuator, and
wherein adjusting the position of the second portion of the wing includes adjusting the position of the second portion of the wing via movement of the mouth-shaped arm of the actuator.

13. The method of claim 11, wherein inserting the one or more spars of the first portion of the wing into the connector includes inserting the one or more spars into one or more first apertures of the connector, and
wherein pulling the one or more pins of the connector includes pulling the one or more pins from one or more second apertures of the connector.

14. The method of claim 13, wherein releasing the one or more pins to secure the wing to the connector includes releasing the one or more pins through the one or more second apertures of the connector such that an end of the one or more pins is snapped into a notch of the one or more spars that are inserted through the one or more first apertures of the connector.

15. The method of claim 13, further comprising: pulling the one or more pins that are snapped into the notch of the one or more spars until the one or more pins are released from the notch;
removing the one or more spars of the first portion of the wing from the connector; and
removing the second portion of the wing from the actuator.

16. A system comprising:
an assembly configured to maintain a plurality of wings on an aircraft, the assembly comprising:
a connector comprising a plurality of connecting portions, wherein each connecting portion of the connecting portions is configured to removably connect to a first portion of each wing of the plurality of wings, respectively; and
a plurality of actuators wherein each actuator of the plurality of actuators is configured to have a mechanism configured to removably engage a second portion of each wing of the plurality of wings, respectively,
wherein the second portion of each wing is configured to be moveable;
wherein each actuator of the plurality of actuators is configured to control the movable portion of the wing of the plurality of wings.

17. The system of claim 16, wherein each actuator of the actuators is configured to control the second portion of the wing of the plurality of wings, independently.

18. The system of claim 16, wherein the assembly is configured to connected to a spine of a fuselage of the aircraft.

19. The system of claim 18, wherein the assembly is configured to maintain at least two of the plurality of wings in different directions.

20. The system of claim 16, wherein each connecting portion of the connecting portions includes one or more first apertures and one or more second apertures,
wherein one or more spars of the first portion of the wing are inserted via the one or more first apertures,
wherein the at least one pin is configured to be inserted via the one or more second apertures, and
wherein the at least one pin inserted into the one or more second apertures is configured to be snapped into a notch of the one or more spars inserted into the one or more first apertures.
